(19) United States
(12) Patent Application Publication
(10) Pub. No.: US 2015/0267155 A1
(43) Pub. Date: Sep. 24, 2015

(54) LAUNDRY UNIT DOSE ARTICLE

(71) Applicant: The Procter & Gamble Company, Cincinnati, OH (US)

(72) Inventors: Alan Thomas BROOKER, Newcastle upon Tyne (GB); Philip Frank SOUTER, Northumberland (GB); Andrew John SMITH, Newcastle upon Tyne (GB); Jose David BAEZ CHAVEZ, Newcastle upon Tyne (GB)

(21) Appl. No.: 14/666,329

(22) Filed: Mar. 24, 2015

(30) Foreign Application Priority Data
Mar. 24, 2014 (EP) 14161368.7

(51) Int. Cl. C11D 17/04; C11D 11/00

(52) U.S. Cl. CPC C11D 17/043; C11D 11/0017

(57) ABSTRACT

A multicompartment water-soluble unit dose article comprising a water-soluble film and a liquid laundry detergent composition, wherein at least one compartment of the unit dose article comprises the liquid laundry detergent composition and wherein the unit dose has a height, a width and a length, wherein;
the maximum length is between about 2 and about 5 cm;
the maximum width is between about 2 and about 5 cm; and
the maximum height is between about 3 and about 5 cm;
and wherein the volume of the liquid laundry detergent composition within the water-soluble unit dose is between about 10 and about 20 ml.

Methods of using such unit dose articles.

### FIELD OF THE INVENTION

Laundry unit dose articles.

### BACKGROUND OF THE INVENTION

Laundry unit dose articles have become very popular with the consumer. Such articles are usually constructed of one or more water-soluble films shaped to provide at least one internal compartment. Contained within the internal compartment is a laundry detergent composition. Upon addition to water, the water-soluble film dissolves releasing the composition in to the wash liquor.

Such unit dose articles have found most popularity when used in automatic laundry washing machines. The unit dose article is added to the drum of the washing machine together with the fabrics/garments to be washed. Upon addition of water to the wash process, the water-soluble film dissolves releasing the composition into the wash liquor of the drum.

An issue with the addition of a unit dose article to the drum of a washing machine is the potential for the article to get trapped within the seal of the washing machine. Automatic laundry washing machines comprise a seal between the door and the drum. The seal is often made from a flexible rubber material and comprises a bellows. The bellows allows for differential movement of the drum without breaking the seal between the drum and the door and so prevent wash liquor and items from leaking out of the drum during the wash cycle. It has been observed that sometimes unit dose articles may become trapped between the door and the seal or even within the bellows of the seal.

If the unit dose article becomes trapped then this can impact the ability of the article to dissolve during the wash and release the cleaning composition into the drum. This then impacts the consumer experience due to potentially lower than expected cleaning performance and/or undissolved unit dose film material remaining at the end of the wash.

There remains a need in the art for a unit dose article that is less likely to be trapped between the door and the seal, or within the seal itself of an automatic laundry washing machine.

### SUMMARY OF THE INVENTION

A first aspect of the present invention is a multicompartment water-soluble unit dose article comprising a water-soluble film and a liquid laundry detergent composition, wherein at least one compartment of the unit dose article comprises the liquid laundry detergent composition and wherein the unit dose has a height, a width and a length, and wherein;
the maximum length is between 2 and 5 cm;
the maximum width is between 2 and 5 cm; and
the maximum height is between 3 and 5 cm wherein the volume of the liquid laundry detergent composition within the water-soluble unit dose is between 10 and 20 ml.

A second aspect of the present invention is a method of washing laundry in an automatic laundry machine using a unit dose article according to the present invention, wherein the wash temperature is 30° C. or less, and preferably, wherein the method comprises at least one wash cycle having a duration of between 5 and 20 minutes.

### BRIEF DESCRIPTION OF THE DRAWINGS

FIG. 1. a three-dimensional view of a unit dose article according to the present invention;

FIG. 2. a side view of a unit dose article according to the present invention;

FIG. 3. a top view of a unit dose article according to the present invention.

FIG. 4. A side cut-out view of a washing machine used in the process according to the present invention.

FIG. 5. A close-up side cut-out view of a washing machine used in the process according to the present invention.

### DETAILED DESCRIPTION OF THE INVENTION

The Inventors surprisingly found that the unit dose articles according to the present disclosure were less likely to become trapped between the door and the seal, or within the seal itself of an automatic laundry washing machine.

### Multicompartment Water-Soluble Unit Dose Article

The water-soluble unit dose article comprises a water-soluble film and a liquid laundry detergent composition. The water-soluble film and liquid laundry detergent composition are described in more detail below.

The unit dose article has a height, a width and a length. The maximum of any of these dimensions is meant to mean the greatest distance between two points on opposite sides of the unit dose article. In other words, the unit dose article may not have straight sides and so may have variable lengths, widths and heights depending on where the measurement is taken. Therefore, the maximum should be measured at any two points that are the furthest apart from each other.

The maximum length is between 2 cm and 5 cm, or even between 2 cm and 4 cm, or even between 2 cm and 3 cm. The maximum length maybe greater than 2 cm and less than 6 cm

The maximum width is between 2 cm and 5 cm. The maximum width maybe greater than 3 cm and less than 6 cm.

The maximum height is between 2 cm and 5 cm. The maximum height maybe greater than 2 cm and less than 4 cm. The maximum height is between 3 cm and 5 cm.

Preferably, the length:height ratio is from 3:1 to 1:1; or the width:height ratio is from 3:1 to 1:1, or even 2.5:1 to 1:1; or the ratio of length to height is from 3:1 to 1:1 and the ratio of width to height is from 3:1 to 1:1, or even 2.5:1 to 1:1, or a combination thereof.

Without wishing to be bound by theory, the Inventors found that by carefully regulating the length, width and height of the unit dose article, they were less likely to become trapped between the door and the seal, or within the seal itself of an automatic laundry washing machine.

The volume of the liquid laundry detergent composition within the unit dose article is between 10 and 27 ml, preferably between 10 and 23 ml, preferably between 10 and 20 ml. Without wishing to be bound by theory, it was found that by carefully regulating the volume, the unit dose article was less likely to become trapped between the door and the seal, or within the seal itself of an automatic laundry washing machine.

The unit dose article may have a weight of less than 30 g, or even between 10 g and 28 g, or even between 10 g and 25 g. Without wishing to be bound by theory, it was found that by carefully regulating the weight, the unit dose article was less likely to become trapped between the door and the seal, or within the seal itself of an automatic laundry washing machine.

The liquid laundry detergent composition may have a weight of between 0.6 g/L and less than 1 g/L. Those skilled in the art will know how to use routine laboratory test methods to calculate the weight of the liquid.

The unit dose article may comprise a gas, and wherein the ratio of the volume of said gas to the volume of the liquid laundry detergent composition is between 1:4 and 1:20, or even between 1:5 and 1:15, or even between 1:5 and 1:9. Without wishing to be bound by theory, it was found that by carefully regulating the volume of gas to volume of liquid the dissolution of the film and dispersion of the liquid laundry detergent composition in the wash liquor could be maximised. There is a tendency of highly concentrated surfactant compositions present in unit dose articles to gel upon contact with water. This gelling effect causes a competition between the internal laundry detergent composition and the film for the available water in the wash liquor. The competition can result in reduced dissolution of the film of the unit dose article. By providing an air interface rather than a detergent interface for the film results in less competition for the available water and increases the dissolution rate of the film.

Without wishing to be bound by theory the Inventors surprisingly found that careful regulation of the envelope density of the water-soluble unit dose article contributed to overcoming the technical problem. The envelope density is a function of the weight of the unit dose article and the volume of the unit dose article. By carefully regulating the internal liquid volume (and weight) to the overall size and volume of the unit dose article, it was found that the unit dose article was less likely to float. This meant that it was more likely to be caught within the fabric wash load in the drum of the washing machine and so be exposed to mechanical turbulence. This is turn reduced the instances of the unit dose article coming into contact with and hence getting caught in the seal.

The water-soluble unit dose article comprises multiple compartments. The unit dose article may comprise two, or three, or four or five compartments.

At least one compartment comprises a composition. Each compartment may comprise the same or a different composition. The unit dose article comprise a liquid composition, however, it may also comprise different compositions in different compartments. The composition may be a solid, liquid, gel, fluid, dispersion or a mixture thereof.

The water-soluble film is shaped such that it defines the shape of the compartment, such that the compartment is completely surrounded by the film. The compartment may be formed from a single film, or multiple films. For example the compartment may be formed from two films which are sealed together (e.g. heat sealed, solvent sealed or a combination thereof). The water-soluble film is sealed such that the composition does not leak out of the compartment during storage. However, upon addition of the water-soluble pouch to water, the water-soluble film dissolves and releases the contents of the internal compartment into the wash liquor.

The water-soluble unit dose article can be of any form, shape and material which is suitable for holding the composition, i.e. without allowing the release of the composition, and any additional component, from the unit dose article prior to contact of the unit dose article with water. The exact execution will depend, for example, on the type and amount of the compositions in the unit dose article. The unit dose article may have a substantially, square, rectangular, oval, elliptoid, superelliptical, or circular shape. The shape may or may not include any excess material present as a flange or skirt at the point where two or more films are sealed together. By substantially, we herein mean that the shape has an overall impression of being for example square. It may have rounded corners and/or non-straight sides, but overall it gives the impression of being square for example.

The maximum length or maximum width or maximum height may include the flange. Alternatively the maximum length, the maximum width, or the maximum height may not include the flange material and may include the compartments only.

A multi-compartment unit dose article form may be desirable for such reasons as: separating chemically incompatible ingredients; or where it is desirable for a portion of the ingredients to be released into the wash earlier or later.

The multiple compartments may be arranged in any suitable orientation. For example the unit dose article may comprise a bottom compartment, and at least a first top compartment, wherein the top compartment is superposed onto the bottom compartment. The unit dose article may comprise a bottom compartment and at least a first and a second top compartment, wherein the top compartments are arranged side-by-side and are superposed on the bottom compartment; preferably, wherein the article comprises a bottom compartment and at least a first, a second and a third top compartment, wherein the top compartments are arranged side-by-side and are superposed on the bottom compartment. The unit dose article may comprise a bottom compartment and at least a first and a second top compartment, wherein the top compartments are arranged side-by-side and are superposed on the bottom compartment; preferably, wherein the article comprises a bottom compartment and at least a first, a second and a third top compartment, wherein the top compartments are arranged side-by-side and are superposed on the bottom compartment, and wherein the maximum length is between 2 cm and 5 cm, or even between 2 cm and 4 cm, or even between 2 cm and 3 cm, the maximum width is between 2 cm and 5 cm and the maximum height is between 2 cm and 5 cm.

The ratio of the surface area to volume ratio of the combined top compartments to the surface area to volume ratio of bottom compartment may be between 1:1.25 and 1:2.25, or even between 1:1.5 and 1:2. In this context the surface area is that which is in contact with the external environment only, and not that which is in contact with a neighbouring compartment. Without wishing to be bound by theory, it was found that the specific ratios of surface area to volume ratio of the top compartments to the bottom compartment helped reduce the instances of the unit dose article becoming trapped.

Alternatively, the compartments may all be positioned in a side-by-side arrangement. In such an arrangement the compartments may be connected to one another and share a dividing wall, or may be substantially separated and simple held together by a connector or bridge. Alternatively, the compartments may be arranged in a ‘tyre and rim’ orientation, i.e. a first compartment is positioned next to a second compartment, but the first compartment at least partially surrounds the second compartment, but does not completely enclose the second compartment.

Preferably, the unit dose article ruptures between 10 seconds and 5 minutes once the unit dose article has been added to 950 ml of deionised water at 20-21° C. in a 1 L beaker, wherein the water is stirred at 350 rpm with a 5 cm magnetic stirrer bar. By rupture, we herein mean the film is seen to visibly break or split. Shortly after the film breaks or splits the internal liquid detergent composition may be seen to exit the unit dose article into the surrounding water.

### Water-Soluble Film

The film of the unit dose article is soluble or dispersible in water, and preferably has a water-solubility of at least 50%, preferably at least 75% or even at least 95%, as measured by the method set out here after using a glass-filter with a maximum pore size of 20 microns:

50 grams ±0.1 gram of film material is added in a pre-weighed 400 ml beaker and 245 ml ±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred film materials are polymeric materials. The film material can be obtained, for example, by casting, blow-moulding, extrusion or blown extrusion of the polymeric material, as known in the art. Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000. Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material. Preferred films exhibit good dissolution in cold water, meaning unheated water straight from the tap. Preferably such films exhibit good dissolution at temperatures below 25° C., more preferably below 21° C., more preferably below 15° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

Preferred water soluble films are those resins comprising one or more PVA polymers, preferably said water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 cP (cP mean centipoise), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20 .deg.C. All viscosities specified herein in cP should be understood to refer to the viscosity of 4% aqueous polyvinyl alcohol solution at 20 .deg.C, unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

The PVA resin can still further include one or more additional PVA polymers that have a viscosity in a range of about 10 to about 40 cP and a degree of hydrolysis in a range of about 84% to about 92%.

When the PVA resin includes a first PVA polymer having an average viscosity less than about 11 cP and a polydispersity index in a range of about 1.8 to about 2.3, then in one type of embodiment the PVA resin contains less than about 30 wt. % of the first PVA polymer. Similarly, when the PVA resin includes a first PVA polymer having an average viscosity less than about 11 cP and a polydispersity index in a range of about 1.8 to about 2.3, then in another, non-exclusive type of embodiment the PVA resin contains less than about 30 wt. % of a PVA polymer having a Mw less than about 70,000 Daltons.

Of the total PVA resin content in the film described herein, the PVA resin can comprise about 30 to about 85 wt. % of the first PVA polymer, or about 45 to about 55 wt. % of the first PVA polymer. For example, the PVA resin can contain about 50 wt. % of each PVA polymer, wherein the viscosity of the first PVA polymer is about 13 cP and the viscosity of the second PVA polymer is about 23 cP.

One type of embodiment is characterized by the PVA resin including about 40 to about 85 wt. % of a first PVA polymer that has a viscosity in a range of about 10 to about 15 cP and a degree of hydrolysis in a range of about 84% to about 92%. Another type of embodiment is characterized by the PVA resin including about 45 to about 55 wt. % of the first PVA polymer that has a viscosity in a range of about 10 to about 15 cP and a degree of hydrolysis in a range of about 84% to about 92%. The PVA resin can include about 15 to about 60 wt. % of the second PVA polymer that has a viscosity in a range of about 20 to about 25 cP and a degree of hydrolysis in a range of about 84% to about 92%. One contemplated class of embodiments is characterized by the PVA resin including about 45 to about 55 wt. % of the second PVA polymer.

When the PVA resin includes a plurality of PVA polymers the PDI value of the PVA resin is greater than the PDI value of any individual, included PVA polymer. Optionally, the PDI value of the PVA resin is greater than 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

Preferably the PVA resin has a weighted, average degree of hydrolysis ( H̅°̅) between about 80 and about 92%, or between about 83 and about 90%, or about 85 and 89%. For example, H̅°̅ for a PVA resin that comprises two or more PVA polymers is calculated by the formula H̅°̅=Σ(Wi·Hᵢ) where Wᵢ is the weight percentage of the respective PVA polymer and a Hᵢ is the respective degrees of hydrolysis. Still further it is desirable to choose a PVA resin that has a weighted log viscosity ( μ̅) between about 10 and about 25, or between about 12 and 22, or between about 13.5 and about 20. The μ̅ for a PVA resin that comprises two or more PVA polymers is calculated by the formula μ̅=e^{ΣW}^{ᵢ}^{·ln μ}^{ᵢ} where μᵢ is the viscosity for the respective PVA polymers.

Yet further, it is desirable to choose a PVA resin that has a Resin Selection Index (RSI) in a range of 0.255 to 0.315, or 0.260 to 0.310, or 0.265 to 0.305, or 0.270 to 0.300, or 0.275 to 0.295, preferably 0.270 to 0.300. The RSI is calculated by the formula; Σ(Wᵢ|μᵢ−μₜ|)/Σ(Wᵢμᵢ), wherein μₜ is seventeen, μᵢ is the average viscosity each of the respective PVOH polymers, and Wᵢ is the weight percentage of the respective PVOH polymers.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including water, to be delivered to the wash water, for example organic polymeric dispersants, etc.

The film may be lactone free. By this we mean that the film does not comprise any lactone. Alternatively, the film may comprise very low levels of lactone that are present due to impurities but which have not been deliberately added. However, essentially the film will be free of lactone.

The film may comprise an area of print. The area of print may cover the entire film or part thereof. The area of print may comprise a single colour or maybe comprise multiple colours, even three colours. The area of print may comprise pigments, dyes, bluing agents or mixtures thereof. The print may be present as a layer on the surface of the film or may at least partially penetrate into the film. The unit dose article may comprise at least two films, or even at least three films, wherein the films are sealed together. The area of print may be present on one film, or on more than film, e.g. on two films, or even on three films.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either side of the film.

The area of print may be purely aesthetic or may provide useful information to the consumer.

The area of print may be opaque, translucent or transparent.

### Liquid Laundry Detergent Composition

The unit dose article comprises a liquid laundry detergent composition. The liquid composition may be opaque, transparent or translucent. Each compartment may comprise the same or a different composition. The unit dose article comprises a liquid composition, however, it may also comprise different compositions in different compartments. The composition may be any suitable composition. The composition may be in the form of a solid, a liquid, a dispersion, a gel, a paste, a fluid or a mixture thereof. The composition may be in different forms in the different compartments. Non-limiting examples of compositions include cleaning compositions, fabric care compositions, automatic dishwashing compositions and hard surface cleaners. More particularly, the compositions may be a laundry, fabric care or dish washing composition including, pre-treatment or soaking compositions and other rinse additive compositions. The laundry detergent composition may be used during the main wash process or could be used as pre-treatment or soaking compositions.

Laundry detergent compositions include fabric detergents, fabric softeners, 2-in-1 detergent and softening, pre-treatment compositions and the like. Laundry detergent compositions may comprise surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments and mixtures thereof. The composition may be a laundry detergent composition comprising an ingredient selected from the group comprising a shading dye, surfactant, polymers, perfumes, encapsulated perfume materials, structurant and mixtures thereof.

The liquid laundry detergent composition may comprise an ingredient selected from, bleach, bleach catalyst, dye, hueing dye, cleaning polymers including alkoxylated polyamines and polyethyleneimines, soil release polymer, surfactant, solvent, dye transfer inhibitors, chelant, enzyme, perfume, encapsulated perfume, polycarboxylates, structurant and mixtures thereof.

Surfactants can be selected from anionic, cationic, zwitterionic, non-ionic, amphoteric or mixtures thereof. Preferably, the fabric care composition comprises anionic, non-ionic or mixtures thereof.

The anionic surfactant may be selected from linear alkyl benzene sulfonate, alkyl ethoxylate sulphate and combinations thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. In one aspect, R¹ is an alkyl group, which may be primary or secondary, that comprises from about 9 to 15 carbon atoms, or from about 10 to 14 carbon atoms. In one aspect, the alkoxylated fatty alcohols will also be ethoxylated materials that contain on average from about 2 to 12 ethylene oxide moieties per molecule, or from about 3 to 10 ethylene oxide moieties per molecule.

The shading dyes employed in the present laundry detergent compositions may comprise polymeric or non-polymeric dyes, pigments, or mixtures thereof. Preferably the shading dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred.

The shading dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

The dye may be introduced into the detergent composition in the form of the unpurified mixture that is the direct result of an organic synthesis route. In addition to the dye polymer therefore, there may also be present minor amounts of un-reacted starting materials, products of side reactions and mixtures of the dye polymers comprising different chain lengths of the repeating units, as would be expected to result from any polymerisation step.

The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

The laundry detergent compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition.

The composition may comprise a brightener. Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

The laundry detergent composition may comprise one or more polymers. Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other suitable cellulosic polymers may have a degree of substitution (DS) of from 0.01 to 0.99 and a degree of blockiness (DB) such that either DS+DB is of at least 1.00 or DB+2DS−DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose.

Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Suitable suds suppressors include silicone and/or fatty acid such as stearic acid.

The liquid laundry detergent composition maybe coloured. The colour of the liquid laundry detergent composition may be the same or different to any printed area on the film of the article. Each compartment of the unit dose article may have a different colour. Preferably, the liquid laundry detergent composition comprises a non-substantive dye having an average degree of alkoxylation of at least 16.

At least one compartment of the unit dose article may comprise a solid. If present, the solid may be present at a concentration of at least 5% by weight of the unit dose article.

### Method of Making the Pouch

The present invention is also to a method of making the unit dose article according to the present invention. The process of the present invention may be continuous or intermittent. The process comprises the general steps of forming an open pouch, preferably by forming a water-soluble film into a mould to form said open pouch, filling the open pouch with a composition, closing the open pouch filled with a composition, preferably using a second water-soluble film to form the unit dose article. The second film may also comprise compartments, which may or may not comprise compositions. Alternatively, the second film may be a second closed pouch containing one or more compartments, used to close the open pouch. Preferably, the process is one in which a web of unit dose article are made, said web is then cut to form individual unit dose articles.

Alternatively, the first film may be formed into an open pouch comprising more than one compartment. In which case, the compartments formed from the first pouch may are in a side-by-side or ‘tyre and rim’ orientation. The second film may also comprise compartments, which may or may not comprise compositions. Alternatively, the second film may be a second closed pouch used to close the multicompartment open pouch.

The unit dose article may be made by thermoforming, vacuum-forming or a combination thereof. Unit dose articles may be sealed using any sealing method known in the art. Suitable sealing methods may include heat sealing, solvent sealing, pressure sealing, ultrasonic sealing, pressure sealing, laser sealing or a combination thereof.

The unit dose articles may be dusted with a dusting agent. Dusting agents can include talc, silica, zeolite, carbonate or mixtures thereof.

An exemplary means of making the unit dose article of the present invention is a continuous process for making an article according to any preceding claims, comprising the steps of:
a. continuously feeding a first water-soluble film onto a horizontal portion of an continuously and rotatably moving endless surface, which comprises a plurality of moulds, or onto a non-horizontal portion thereof and continuously moving the film to said horizontal portion;
b. forming from the film on the horizontal portion of the continuously moving surface, and in the moulds on the surface, a continuously moving, horizontally positioned web of open pouches;
c. filling the continuously moving, horizontally positioned web of open pouches with a product, to obtain a horizontally positioned web of open, filled pouches;
d. preferably continuously, closing the web of open pouches, to obtain closed pouches, preferably by feeding a second water-soluble film onto the horizontally positioned web of open, filed pouches, to obtain closed pouches; and
e. optionally sealing the closed pouches to obtain a web of closed pouches.

The second water-soluble film may comprise at least one open or closed compartment.

In one embodiment, a first web of open pouches is combined with a second web of closed pouches preferably wherein the first and second webs are brought together and sealed together via a suitable means, and preferably wherein the second web is a rotating drum set-up. In such a set-up, pouches are filled at the top of the drum and preferably sealed afterwards with a layer of film, the closed pouches come down to meet the first web of pouches, preferably open pouches, formed preferably on a horizontal forming surface. It has been found especially suitable to place the rotating drum unit above the horizontal forming surface unit.

Preferably, the resultant web of closed pouches are cut to produce individual unit dose articles.

The film may comprise an area of print. The area of print may cover the entire film or part thereof. The area of print may comprise a single colour or maybe comprise multiple colours, even three colours. The area of print may comprise white, black and red colours. The area of print may comprise pigments, dyes, bluing agents or mixtures thereof. The print may be present as a layer on the surface of the film or may at least partially penetrate into the film. The area of print may be present on the outside of the unit dose article, or maybe on the inner surface of the film, i.e. in contact with the liquid laundry detergent composition. Alternatively, the area of print may be present ion both the outside and the inside of the unit dose article.

The unit dose article may comprise at least two films, or even at least three films, wherein the films are sealed together. The area of print may be present on one film, or on more than film, e.g. on two films, or even on three films.

The area of print may be achieved using standard techniques, such as flexographic printing or inkjet printing. Preferably, the area of print is achieved via flexographic printing, in which a film is printed, then moulded into a unit dose article via steps a-e above. Printing may be on the inside or the outside of the unit dose article.

Those skilled in the art would recognize the appropriate size of mould needed in order to make a unit dose article according to the present invention.

### Method of Using the Unit Dose Article

The present invention is also to a process for the machine washing of laundry using an article according to the present invention, comprising the steps of, placing at least one article according to the present invention into the washing machine along with the laundry to be washed, and carrying out a washing or cleaning operation.

Any suitable washing machine may be used. Those skilled in the art will recognize suitable machines for the relevant wash operation. The article of the present invention may be used in combination with other compositions, such as fabric additives, fabric softeners, rinse aids and the like.

The wash temperature may be 30° C. or less. The wash process may comprise at least one wash cycle having a duration of between 5 and 20 minutes. The automatic laundry machine may comprise a rotating drum, and wherein during at least one wash cycle, the drum has a rotational speed of between 15 and 40 rpm, preferably between 20 and 35 rpm.

The wash process maybe performed in an automatic washing machine wherein the automatic washing machine comprises a drum, a door and a seal, wherein the drum comprises a top, a bottom and an opening; and wherein the door comprises a front, a back and a side wall, and wherein the back of the door has an overhang into the drum; and wherein the seal is located between the opening of the drum and the door; and wherein, the seal comprises a bellows, and wherein the bellows comprises an opening; and wherein;
a) the height from the bottom of the drum to the seal is between 7 and 15 cm;
b) the angle from a horizontal plane to the side of the door is between 5° and 30°;
c) is the angle from a horizontal plane and the seal is between 0° and 25°;
d) the width of the opening of the bellow is less than 2 cm;
e) the overhang is between 0 and 6 cm.

### Example

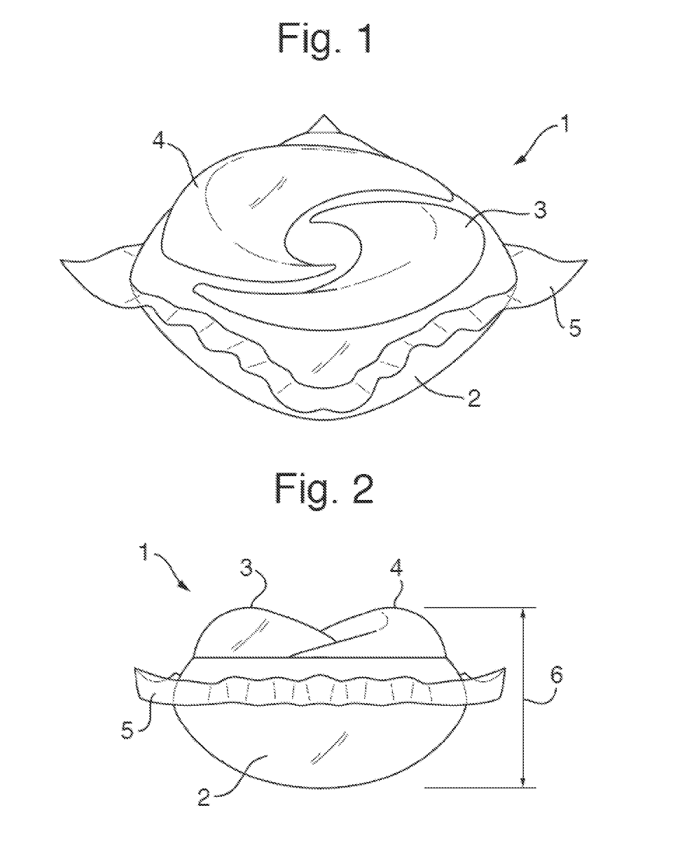

FIG. 1 is to a multicompartment unit dose article (1) according to the present invention. The unit dose article (1) comprises a bottom compartment (2), a first top compartment (3) and a second top compartment (4). The unit dose article also comprises a flange (5).

The unit dose article (1) comprises three films. The top compartments (3, 4) are formed from a first and a second film which are sealed together. The sealed top compartments are then used to close the bottom (2) which is formed of a third film. The sealed top compartments are sealed to the film of the bottom compartment. Any suitable sealing means including solvent sealing, heat sealing or both may be used.

FIG. 2. is a side view of the unit dose article (1). The maximum height (6) is the greatest distance between two points on opposite sides of the unit dose article. The maximum height (6) is between 2 and 5 cm or even between 2 cm and 4 cm, or even between 2 cm and 3 cm.

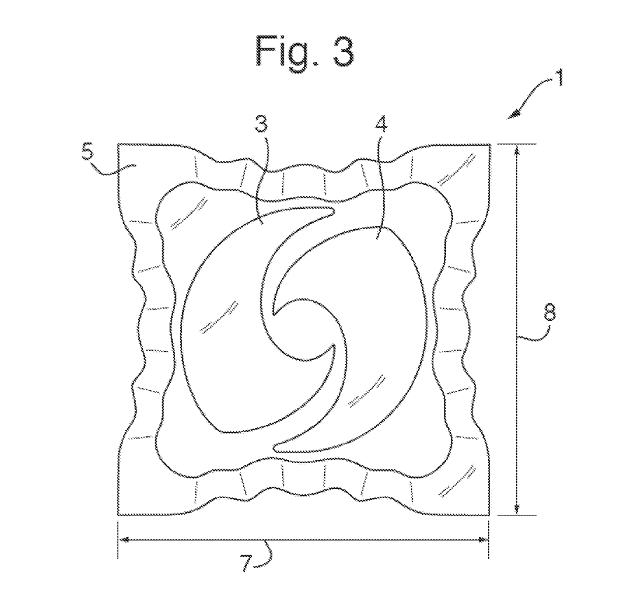

FIG. 3. is a top view of the unit dose article (1). The maximum width (7) is the greatest distance between two points on opposite sides of the unit dose article and the maximum length (8) is the greatest distance between two points on opposite sides of the unit dose article. The maximum width is between 2 cm and 5 cm, and the maximum length is between 2 cm and 5 cm.

The unit dose article (1) has a length:height ratio from 3:1 to 1:1; a width:height ratio from 3:1 to 1:1, or even 2.5:1 to 1:1; a ratio of length to height from 3:1 to 1:1.

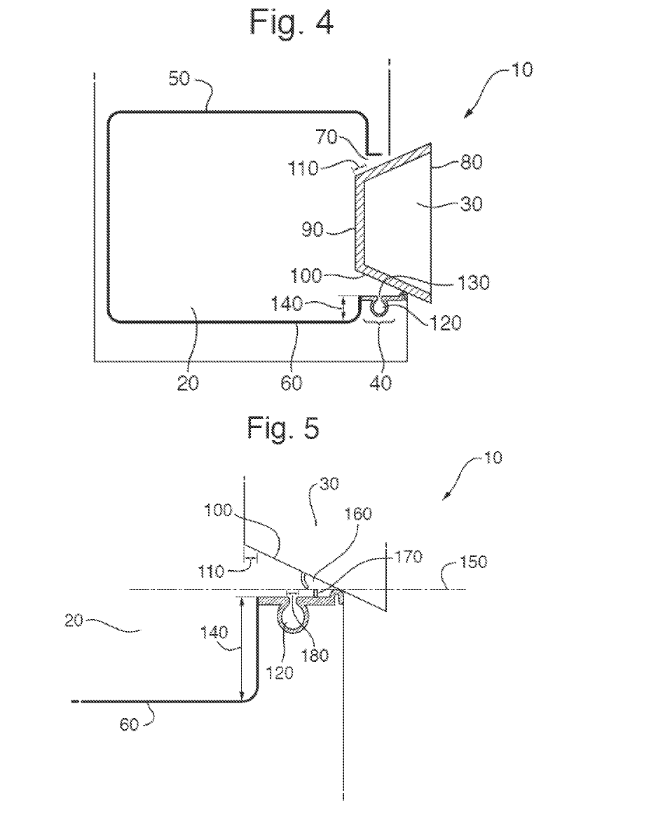

FIG. 4. is to an automatic washing machine (10) according to the present invention comprising a drum (20), a door (30) and a seal (40). The drum (20) comprises a top (50), a bottom (60) and an opening (70). The door (30) comprises a front (80), a back (90) and a side wall (100), and wherein the back of the door has an overhang (110) into the drum (20). The seal (40) is located between the opening of the drum (70) and the door (30). The seal (30) comprises a bellows (120), and wherein the bellows (120) comprises an opening (130).

FIG. 5. is a close up of the automatic washing machine (10) of FIG. 1. The height (140) from the bottom of the drum (60) to the seal (40) is between 7 and 15 cm. The angle (160) from a horizontal plane (150) to the side of the door (100) is between 5° and 30°. The angle (170) from a horizontal plane (150) to the seal (40) is between 0° and 25°. The width (180) of the opening of the bellow (130) is less than 2 cm. The overhang (110) is between 0 and 6 cm.

The unit dose article (1) has a volume of from 10 to 27 ml and a weight of less than 30 g.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within

What is claimed is:

1. A multicompartment water-soluble unit dose article comprising a water-soluble film and a liquid laundry detergent composition, wherein at least one compartment of the unit dose article comprises the liquid laundry detergent composition and wherein the unit dose article has a height, a width and a length, wherein;
the maximum length is between about 2 and about 5 cm;
the maximum width is between about 2 and about 5 cm; and
the maximum height is between about 3 and about 5 cm,
and wherein the volume of the liquid laundry detergent composition within the water-soluble unit dose is between about 10 and about 20 ml.

2. The multicompartment article according to claim 1, wherein the maximum height is between about 2 cm and about 4 cm.

3. The multicompartment article according to claim 1, wherein the liquid laundry detergent composition has a weight of between about 0.7 g/L and about 1 g/L.

4. The multicompartment article according to claim 1, wherein the article has a weight of less than about 30 g.

5. The multicompartment article according to claim 1, wherein the article has a weight of between about 10 g and about 28 g.

6. The multicompartment article according to claim 1, wherein the article comprises a bottom compartment, and at least a first top compartment, wherein the top compartment is superposed onto the bottom compartment.

7. The multicompartment article according to claim 6, comprising a bottom compartment and at least a first and a second top compartment, wherein the top compartments are arranged side-by-side and are superposed on the bottom compartment;

8. The multicompartment article according to claim 6, wherein the article comprises a bottom compartment and at least a first, a second and a third top compartment, wherein the top compartments are arranged side-by-side and are superposed on the bottom compartment.

9. The multicompartment article according to claim 6, wherein the ratio of the surface area to volume ratio of the combined top compartments to the surface area to volume ratio of bottom compartment is between about 1:1.25 and about 1:2.25.

10. The multicompartment article according to claim 9, wherein the ratio of the surface area to volume ratio of the combined top compartments to the surface area to volume ratio of bottom compartment is between about 1:1.5 and about 1:2.

11. The multicompartment article according to claim 1, wherein:
(a) the length:height ratio is from 3:1 to 1:1; or
(b) the width:height ratio is from 3:1 to 1:1, or
(c) a combination thereof.

12. The multicompartment article according to claim 11, wherein the ratio of length to height is from 3:1 to 1:1, and wherein the ratio of width to height is from 3:1 to 1:1.

13. The multicompartment unit dose article according to claim 1, wherein at least one compartment comprises a solid and wherein the solid is present at a concentration of at least about 5% by weight of the multicompartment article.

14. The multicompartment unit dose article according to claim 1, wherein the liquid laundry detergent composition comprises an ingredient selected from: bleach, bleach catalyst, dye, hueing dye, cleaning polymers including alkoxylated polyamines and polyethyleneimines, soil release polymer, surfactant, solvent, dye transfer inhibitors, chelant, enzyme, perfume, encapsulated perfume, polycarboxylates, structurant, and mixtures thereof.

15. The multicompartment unit dose article according to claim 1, wherein the unit dose article ruptures between about 10 seconds and about 5 minutes once the unit dose article is added to about 950 ml of deionised water at about 20-21° C. in a 1 L beaker, wherein the water is stirred at about 350 rpm with a 5 cm magnetic stirrer bar.

16. The multicompartment unit dose article according to claim 1, wherein the film is lactone free.

17. The multicompartment unit dose article according to claim 1, wherein the unit dose article comprises a gas, and wherein the ratio of the volume of said gas to the volume of the liquid laundry detergent composition is between about 1:4 and about 1:20.

18. A method of washing laundry in an automatic laundry machine using a unit dose article according to claim 1, wherein the wash temperature is about 30° C. or less, and optionally, wherein the method comprises at least one wash cycle having a duration of between about 5 and about 20 minutes.

19. The method according to claim 18, wherein the automatic laundry machine comprises a rotating drum, and wherein during at least one wash cycle, the drum has a rotational speed of between about 15 and about 40 rpm.

20. The method according to claim 1, wherein the automatic washing machine comprises a drum, a door and a seal,
wherein the drum comprises a top, a bottom and an opening; and
wherein the door comprises a front, a back and a side wall, and wherein the back of the door has an overhang into the drum; and
wherein the seal is located between the opening of the drum and the door; and
wherein, the seal comprises a bellows, and wherein the bellows comprises an opening; and
wherein;
a) the height from the bottom of the drum to the seal is between about 7 and about 15 cm;
b) the angle from a horizontal plane to the side of the door is between about 5° and about 30°;
c) is the angle from a horizontal plane and the seal is between about 0° and about 25°;
d) the width of the opening of the bellow is less than about 2 cm;
e) the overhang is between about 0 and about 6 cm.
